(19) United States
(12) Patent Application Publication
(10) Pub. No.: US 2011/0042531 A1
(43) Pub. Date: Feb. 24, 2011

(54) BI-POD/TRI-POD STABILIZING WEIGHT

(76) Inventor: Karl Eric Hughes, Phoenix, AZ (US)

Correspondence Address: ROBERT A. PARSONS, 4000 N. CENTRAL AVENUE, SUITE 1220, PHOENIX, AZ, 85012, US

(21) Appl. No.: 12/545,532

(22) Filed: Aug. 21, 2009

(51) Int. Cl. F16M 11/04; F16M 11/00

(52) U.S. Cl. 248/176.1; 33/299

(57) ABSTRACT

A stabilizing weight for use with a survey instrument stand includes a pouch having weight receiving openings therein. The pouch includes closure structure positioned to close the weight receiving openings after a plurality of weight elements are positioned in the weight receiving openings. An attaching device is affixed to the pouch and formed to secure the pouch to a component of the survey instrument stand, such as a leg, etc.

### FIELD OF THE INVENTION

This invention generally relates to stabilizing weights for instrument bi-pod and tri-pod stands and the like.

### BACKGROUND OF THE INVENTION

Many different surveying instruments are used both in surveying and in the construction industry. For example, at the present time many instruments used for leveling in constructing buildings, roads, etc. include a laser to transmit a highly directional beam and targets to redirect the beam so that both height and distance can be very accurately measured. Both the transmitter and the targets are mounted on some type of stand which allows them to stand upright at some distance above the ground and any interfering obstacles. In many applications either or both of the transmitter and the target or targets are at least temporarily unmanned. Thus, they can be adversely affected by wind etc. If, for example, the wind moves a target even a fraction of an inch, the entire process may have to be restarted or at least partially redone.

In this disclosure it should be understood that the term “survey instrument stand” includes any free-standing device used in the survey and construction arts and includes stands such as bi-pods and tri-pods. Also, the term “survey” is intended to include any distance and/or height measurements in any of the various applications in which free-standing devices are used. Further, it is immediately apparent that survey devices incorporating survey instrument stands are substantially different than other free standing devices because they must survive winds and other disturbances while remaining unattended for the periods of time required to perform survey and leveling functions.

It would be highly advantageous, therefore, to remedy the foregoing and other deficiencies inherent in the prior art.

Accordingly, it is an object of the present invention to provide new and improved stabilizing apparatus for survey instrument stands.

Another object of the invention is to provide new and improved stabilizing apparatus that is convenient to use and adjust.

Another object of the invention is to provide new and improved stabilizing apparatus that is easily transported and carried and can be easily and quickly adjusted.

### SUMMARY OF THE INVENTION

Briefly, to achieve the desired objects of the instant invention in accordance with a preferred embodiment thereof, provided is a stabilizing weight for use with a survey instrument stand. The stabilizing weight includes a pouch having weight receiving openings therein. The pouch includes closure structure positioned to close the weight receiving openings after a plurality of weight elements are positioned in the weight receiving openings. An attaching device is affixed to the pouch and formed to secure the pouch to a component of the survey instrument stand, such as a leg, etc.

Briefly, the desired objects of the instant invention are further achieved in accordance with a specific method of stabilizing a survey instrument stand including the steps of providing a survey instrument stand that is freestanding and includes a plurality of supporting legs. The method further includes a step of providing a stabilizing weight including a pouch having weight receiving openings therein and including closure structure positioned to close the weight receiving openings, the pouch including an attaching device affixed to the pouch for securing the pouch to one supporting leg of the survey instrument stand. The method further includes a steps of providing a plurality of weight elements and positioning each weight element of the plurality of weight elements in a different one of the weight receiving openings in the pouch, closing the weight receiving openings with the closure structure, and securing the stabilizing weight to one supporting leg of the survey instrument stand.

### BRIEF DESCRIPTION OF THE DRAWINGS

The foregoing and further and more specific objects and advantages of the instant invention will become readily apparent to those skilled in the art from the following detailed description of a preferred embodiment thereof taken in conjunction with the drawings, in which:

FIG. 1 is top perspective view of an embodiment of a stabilizing weight for survey instrument stands in accordance with the present invention;

FIG. 2 is a top perspective view of the stabilizing weight of FIG. 1 in a rolled or gripping mode;

FIG. 3 is a side perspective view of a survey instrument having three stabilizing weights similar to the stabilizing weight of FIG. 1 attached to the three legs of the survey instrument stand;

FIG. 4 is top perspective view of another embodiment of a stabilizing weight for survey instrument stands in accordance with the present invention; and

FIG. 5 is top perspective view of another embodiment of a stabilizing weight for survey instrument stands in accordance with the present invention.

### DETAILED DESCRIPTION OF THE DRAWINGS

Turning now to the drawings, attention is first directed to FIG. 1 which illustrates one embodiment of a stabilizing weight 10 in accordance with the present invention. Stabilizing weight 10 includes a weight carrying pouch 12 having a plurality of pockets 14 formed therein. In this specific embodiment a plurality of individual pockets 14 are formed, each with a generally elongated parallel configuration designed to receive a relatively heavy weight element, which in this embodiment is a bar 16 formed of material such as lead, iron, etc. therein. Because each of the plurality of individual pockets 14 is constructed separately, any number (up to the number of pockets 14) of bars 16 can be inserted to provide the amount of weight required to stabilize a survey instrument stand under any specific conditions. Closure structure, which in this embodiment is a flap 18 provide as a part of pouch 12, is constructed and positioned to fold back over the openings of pockets 14 and securely hold bars 16 therein. It will be understood that other closure structure might be provided including, for example, extending pockets 14 beyond the ends of bars 16 and closing the pockets by means of Velcro, zippers, etc.

While pockets 14 in pouch 12 are illustrated as thin and elongated to receive elongated bars, it will be understood that they could be somewhat larger in size for receiving different sized bars or weights. Alternatively, while pockets 14 in pouch 12 are illustrated as all the same size, it will be understood that they might be graduated in size to accommodate different sized or shaped bars or weights.

Pouch 12 is further provided with a plurality of attaching devices, such as elongated fiber ribbons 20, that are attached adjacent one end to pouch 12. In the embodiment illustrated in FIG. 1, the attaching device comprises two ribbons 20 spaced apart along the length of pouch 12 with a substantial portion (including the opposite end) of each ribbon 20 hanging free. It will be understood that flap 18 and ribbons 20 include some device for affixing them in the closed or attached orientation. For example, flap 18 and ribbons 20 have associated therewith Velcro material for fixing them in a closed orientation in a well known manner.

It will be understood that pouch 12 could be constructed from any convenient flexible material, such as plastic, cloth, leather, etc. Pockets 14 can be formed in pouch 12 by any suitable method (depending primarily upon the material used) including sewing, gluing, heat bonding, etc. Also, ribbons 20 can similarly be constructed of any convenient flexible material such as plastic, cloth, woven material, leather, rope, wire, etc. and attached by any suitable method.

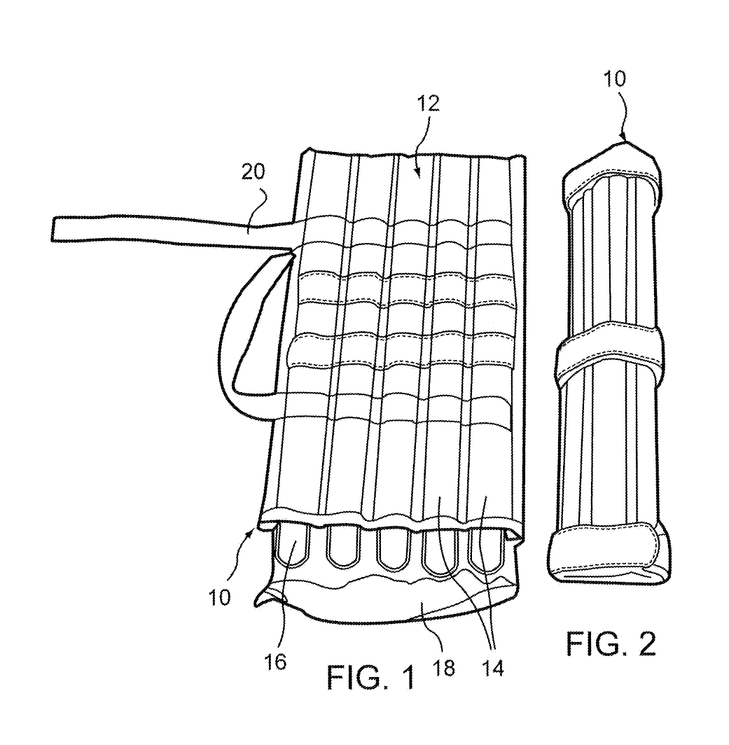

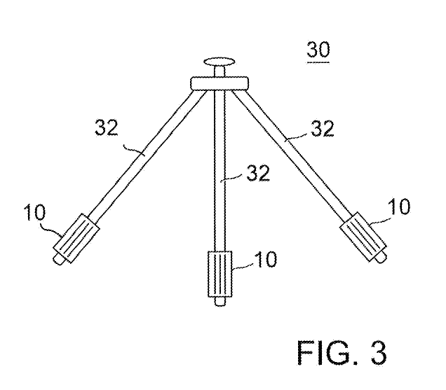

Thus, in operation a user or operator carries one or more pouches 12 and a plurality of bars 16. When it is desired to set up a survey instrument stand 30, illustrated schematically in FIG. 3, the operator opens a pouch 12 and inserts the number of bars 16 required to stabilize the stand. With a desired number of bars 16 inserted in pockets 14 of pouch 12, flap 18 is closed and secured. Pouch 12 is then wrapped around a component of survey stand 30, such as a leg 32, and ribbons 20 are wrapped around pouch 12 to hold stabilizing weight 10 firmly and securely to leg 32. Stabilizing weight 10 is illustrated more clearly in the rolled or gripping mode in FIG. 2.

It should be understood that stabilizing survey instrument stands is different than stabilizing any other structures or stands. First and foremost, survey instrument stands must be capable of being stabilized in virtually any surface conditions from hard surfaces to fluid or nearly fluid surfaces. Also, survey instrument stands must be capable of being stabilized under virtually any atmospheric or surrounding conditions, e.g. wind, rain, etc. Further, survey instrument stands must be capable of being stabilized rapidly and taken-down and moved rapidly. To this end the stabilizing weights must be easily and quickly assembled with the weighting material (e.g. bars, lead shot, etc.) highly accessible and easily carried and stored. If, due to specific conditions, the operator determines that the application of additional stabilizing weights (e.g. stabilizing weights 10, 40, 50) is required, such additional stabilizing weights can be attached to additional legs, as illustrated in FIG. 3. Also, additional stabilizing weights (10, 40, 50) can be attached to any one or more of legs 32 if conditions require it.

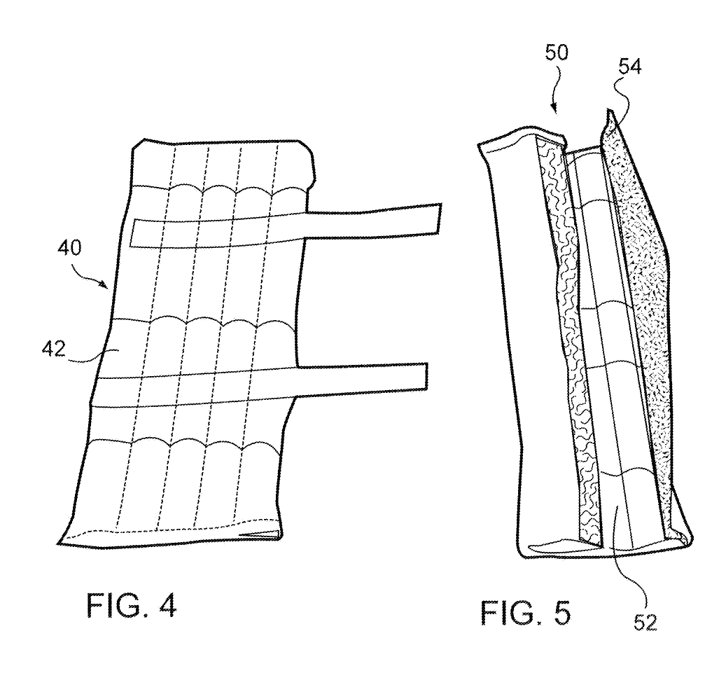

Turning to FIG. 4, another embodiment of a stabilizing weight 40 is illustrated. In this embodiment a pouch 42 is illustrated that is designed to receive different heavy material therein. Pouch 42, for example is designed to receive lead shot or balls as the weighting material. Thus, while stabilizing weight 40 is more variable in weight, it is slightly more inconvenient to use.

Turning to FIG. 5, another embodiment of a stabilizing weight 50 is illustrated. In this embodiment a pouch 50 is provided with a flap 52 as the attaching device. Flap 52 is constructed and positioned to circumferentially secure stabilizing weight 50 around a component (e.g. a leg or the like) of a survey instrument stand. Flap 52 replaces ribbons 20 in the embodiment illustrated in FIG. 1. Thus, it will be understood that a variety of different attaching devices might be used if desired. Also, it can be seen that in some applications stabilizing weights 10 might used in an overlying mode with stabilizing weights 50.

Thus, a completely adjustable stabilizing weight is disclosed that is designed to stabilize any free standing survey instrument stand. Virtually any amount of weight can be provided for stabilizing a survey instrument stand under substantially any conditions occurring during use thereof. The adjustability lies not only in each individual stabilizing weight but in the fact that a plurality of weights can be used in combination. The stabilizing weights are easy to use in that they can be quickly and easily applied, removed, and stored or reapplied in different areas.

Various changes and modifications to the embodiment herein chosen for purposes of illustration will readily occur to those skilled in the art. To the extent that such modifications and variations do not depart from the spirit of the invention, they are intended to be included within the scope thereof which is assessed only by a fair interpretation of the following claims.

Having fully described the invention in such clear and concise terms as to enable those skilled in the art to understand and practice the same, the invention claimed is:

1. A stabilizing weight for use with a survey instrument stand comprising:
a pouch having weight receiving openings therein, the pouch including closure structure positioned to close the weight receiving openings;
a plurality of weight elements positioned in the weight receiving openings; and
an attaching device affixed to the pouch and formed to secure the pouch to a component of the survey instrument stand.

2. A stabilizing weight for use with a survey instrument stand as claimed in claim 1 wherein the pouch is formed of flexible material.

3. A stabilizing weight for use with a survey instrument stand as claimed in claim 2 wherein the weight receiving openings include a plurality of individual, parallel elongated pockets each including a weight receiving opening at one end.

4. A stabilizing weight for use with a survey instrument stand as claimed in claim 3 wherein the closure structure includes a flexible flap positioned to extend over the weight receiving openings and to close the weight receiving openings in a closed orientation.

5. A stabilizing weight for use with a survey instrument stand as claimed in claim 1 wherein the weight elements include elongated bars of heavy material.

6. A stabilizing weight for use with a survey instrument stand as claimed in claim 1 wherein the attaching device includes a plurality of elongated ribbons of flexible material each attached adjacent one end to the pouch and including a length sufficient to encircle the pouch to secure the pouch to a component of the survey instrument stand.

7. A stabilizing weight for use with a survey instrument stand as claimed in claim 1 wherein the attaching device includes a flap formed as a component of the pouch and positioned to at least partially encircle the pouch to secure the pouch to a component of the survey instrument stand.

8. A survey instrument stand and a stabilizing weight comprising:
the survey instrument stand being freestanding and including a plurality of supporting legs; and
a stabilizing weight including a pouch having weight receiving openings therein, the pouch including closure structure positioned to close the weight receiving openings;
a plurality of weight elements positioned in the weight receiving openings; and
an attaching device affixed to the pouch and securing the pouch to one supporting leg of the plurality of supporting legs of the survey instrument stand.

9. A survey instrument stand and a stabilizing weight as claimed in claim 8 further including a plurality of stabilizing weights secured to the plurality of supporting legs of the survey instrument stand.

10. A method of stabilizing a survey instrument stand comprising the steps of:
providing a survey instrument stand that is freestanding and includes a plurality of supporting legs;
providing a stabilizing weight including a pouch having weight receiving openings therein and including closure structure positioned to close the weight receiving openings, the pouch including an attaching device affixed to the pouch for securing the pouch to one supporting leg of the survey instrument stand;
providing a plurality of weight elements; and
positioning each weight element of the plurality of weight elements in a different one of the weight receiving openings in the pouch, closing the weight receiving openings with the closure structure, and securing the stabilizing weight to one supporting leg of the survey instrument stand.

11. A method as claimed in claim 10 including the steps of:
providing a plurality of stabilizing weights each including a pouch having weight receiving openings therein, closure structure positioned to close the weight receiving openings, and an attaching device affixed to the pouch for securing the pouch to one supporting leg of the survey instrument stand; and
positioning each weight element of the plurality of weight elements in a different one of the weight receiving openings in the plurality of pouches, closing the weight receiving openings with the closure structures, and securing the plurality of stabilizing weights one each to a different one of the supporting legs of the survey instrument stand.
